(19) United States
(12) Patent Application Publication
(10) Pub. No.: US 2025/0372336 A1
(43) Pub. Date: Dec. 4, 2025

(54) ANODE ROTATION SENSING IN X-RAY TUBES

(71) Applicant: VAREX IMAGING CORPORATION, Salt Lake City, UT (US)

(72) Inventors: Kendra Jean Davis, Salt Lake City, UT (US); Michael Meiler, Draper, UT (US); Lincoln C. Jolley, Stansbury Park, UT (US); Erinn Scott Sorge, Murray, UT (US); Frank Delatorre, American Fork, UT (US); Chase C. Lewis, Charlottesville, VA (US)

(73) Assignee: VAREX IMAGING CORPORATION, Salt Lake City, UT (US)

(21) Appl. No.: 18/677,244

(22) Filed: May 29, 2024

(51) Int. Cl. H01J 35/10; H01J 35/16; H01J 35/20

(52) U.S. Cl. CPC H01J 35/101; H01J 35/16; H01J 35/20; H01J 2235/1046

(57) ABSTRACT

An x-ray tube includes an enclosure including a wall. The x-ray tube includes a stator positioned external to the wall. The x-ray tube includes a rotatable anode assembly. The rotatable anode assembly includes an anode positioned within the wall. The anode is drivable by the stator to rotate about an axis of rotation. The rotatable anode assembly includes at least one magnet positioned on and rotatable with the anode about the axis of rotation. The x-ray tube includes a sensor configured to sense a magnetic field of the at least one magnet through the wall.

### BACKGROUND

X-rays are a form of high frequency, penetrating electromagnetic radiation, with energy and absorptive properties selected for use in a variety of different medical and industrial settings. Applications include, but are not limited to, medical imaging, diagnostics, radiology, radiotherapy, radiography and tomography, non-destructive testing, materials detection and analysis, and security and inspection. Some x-ray equipment includes x-ray tubes having rotating anode assemblies that have their rotation supported by bearings. The bearings can degrade over time, thereby leading to anode rotation at a slower velocity or acceleration than needed or expected. A mismatch between anode speed and input power can cause further degradation or failure of the x-ray tube due to excessively high temperatures at the anode. There is therefore a need for tracking and responding to anode rotation position and/or speed in x-ray tubes.

### BRIEF DESCRIPTION OF THE DRAWINGS

FIG. 1A illustrates an x-ray tube including at least one magnet and a sensor.

FIG. 1B illustrates an enlarged view of area 1B in FIG. 1A.

FIGS. 2A-2B illustrate exploded views of a sensor and a shield of the x-ray tube of FIGS. 1A-1B.

FIG. 3A illustrates a stator magnetic field in a sensor region of the x-ray tube of FIG. 1B.

FIG. 3B illustrates a stator magnetic field in a sensor region of an x-ray tube without a shield on the sensor.

FIG. 4A illustrates a plot of a signal resulting from a magnet periodically passing a magnetic sensor.

FIG. 4B illustrates a plot of a signal resulting from an anode rotation measurement of an unshielded magnetic sensor.

FIG. 4C illustrates a signal resulting from an anode rotation measurement of the x-ray tube of FIGS. 1A-1B with a first shield installed.

FIG. 4D illustrates a signal resulting from an anode rotation measurement of the x-ray tube of FIGS. 1A-1B with a second shield installed.

FIG. 5A illustrates an end view of one embodiment of a rotating anode assembly of an x-ray tube.

FIG. 5B illustrates an end view of another embodiment of a rotating anode assembly of an x-ray tube.

FIG. 6 is a diagram of a method of detecting rotation of an anode in an x-ray tube.

FIG. 7 illustrates a schematic diagram of an x-ray assembly including an x-ray tube and an anode rotation sensor.

FIG. 8 is a flow chart of a method of an anode rotation speed feedback loop for controlling anode rotation speed.

FIG. 9 is a flow chart of a method of an anode rotation speed feedback loop for controlling anode exposure.

FIG. 10 is a diagram of a method for controlling an x-ray assembly.

### DETAILED DESCRIPTION

The embodiments of the present disclosure are not limited in their application to the details of construction and the arrangement of components set forth in the following description or illustrated in the associated drawings. Various embodiments are capable of other configurations and of being practiced or of being carried out in various ways. Numbers provided in flow charts and processes are provided for clarity in illustrating steps and operations and do not necessarily indicate a particular order or sequence. Unless otherwise defined, the term “or” can refer to a choice of alternatives (e.g., a disjunction operator, or an exclusive or) or a combination of the alternatives (e.g., a conjunction operator, and/or, a logical or, or a Boolean OR). Unless otherwise defined, “connected” can refer to an electrical or mechanical connection. Relative terms such as “about,” “approximately,” or “substantially” indicate that absolute exactness is not required and that features or elements being modified by such terms are within acceptable tolerances as would be recognized by one of ordinary skill in the art. For example, as used herein, the term “substantially parallel” shall be interpreted to include any orientation within five degrees of parallel, or from between 0 and 5 degrees angularly offset from parallel.

Some embodiments relate to x-ray tube anode rotation sensing apparatus, methods, and techniques, such as, for example, inductive sensing techniques for x-ray tubes. Aspects of the present disclosure relate to systems, apparatuses, and methods for providing a direct measurement of a rotation velocity, acceleration, and/or position of a rotatable anode assembly of an x-ray tube.

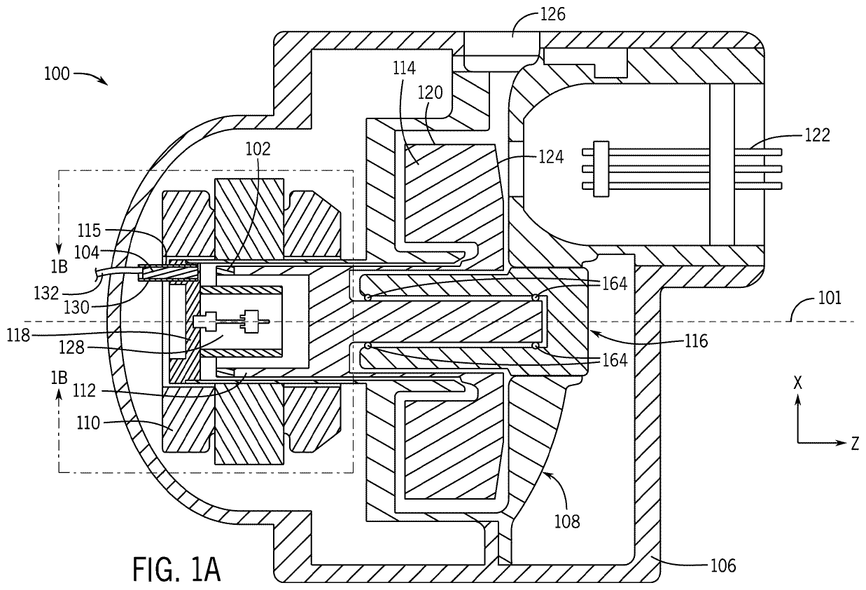

FIG. 1A illustrates an x-ray tube 100 including at least one magnet 102 and a sensor 104 used for detecting rotation of a rotating anode assembly. The x-ray tube 100 includes an enclosure 106, an insert 108 (also referred to as a vacuum envelope), a stator 110, a rotating anode assembly 114 (which includes at least an anode 120/a target 124 and a rotor 112), and a bearing assembly 116. The target 124 can be referred to as an anode track or target track. The cathode assembly 122 can include a cathode and other supporting components which all may be referred to herein as a “cathode.” The rotating anode assembly can be referred to as rotatable anode assembly or an anode assembly.

An anode 120 and a cathode assembly 122 can be operated such that, when the x-ray tube 100 is powered, a potential difference is generated between the cathode assembly 122 and the anode 120. Electrons (e.g., an electron beam) can strike the target 124 portion of the anode 120, and x-rays can be generated and emitted through a window 126 of the x-ray tube 100.

The insert 108 can include a wall 118 (e.g., an end wall or a wall positioned at the motor-end of the insert 108 approximate to the anode 120) positioned on the insert 108 at an opposite end of the rotating anode assembly 114 relative to the cathode assembly 122 of the x-ray tube 100. In some embodiments, the cathode assembly 122 can be positioned on the same side of the x-ray tube 100 as the wall 118. The insert 108 can enclose or house the rotating anode assembly 114 and can therefore be referred to as an enclosure or housing. The rotating anode assembly 114 can include an anode 120 and rotor 112 positioned within the wall 118. The rotor 112 can be magnetically driven by the stator 110 to rotate about an axis of rotation 101 within the enclosure 106 of the x-ray tube 100. Thus, the stator 110 and rotor 112 can be referred to as a motor for the x-ray tube 100. As depicted, the axis of rotation 101 of the rotating anode assembly 114 is positioned on a rotational axis of symmetry of the rotating anode assembly 114 and parallel to a z-axis of a Cartesian (rectangular) coordinate system, as indicated in FIG. 1A. A getter 128 can be placed within the insert 108 to complete and maintain a vacuum environment within the insert 108.

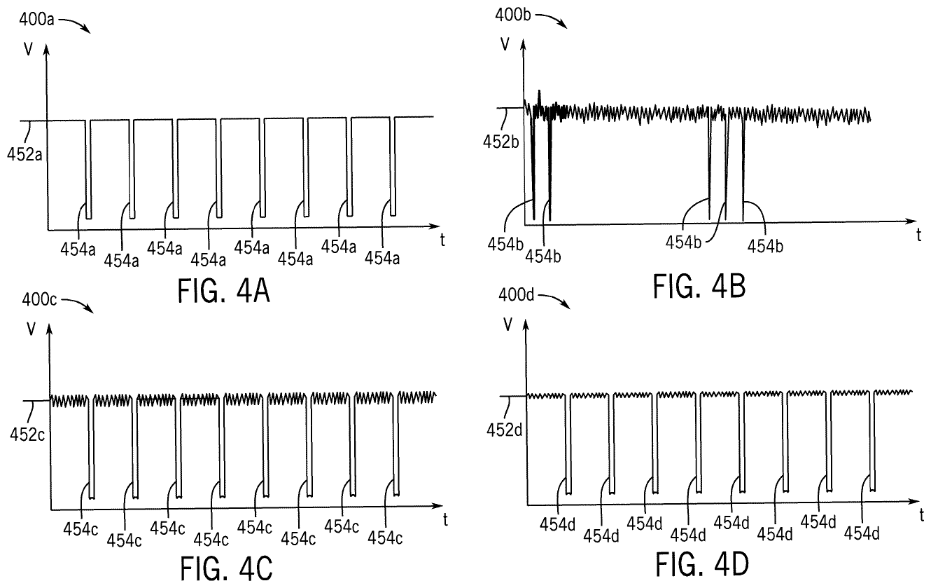

FIG. 1B illustrates an enlarged view of area 1B (indicated by dashed lines in FIG. 1A) of the x-ray tube 100. The rotating anode assembly 114 can include the at least one magnet 102 at an end of the rotor 112, and the at least one magnet 102 can be rotated with the anode 120 about the axis of rotation 101. The rotor 112 can include multiple magnets circumferentially spaced around an outer perimeter of the rotor-end of the rotating anode assembly 114, as discussed in more detail in connection with FIGS. 5A-5B, and can revolve around (e.g., follow a circular trajectory centered on) the axis of rotation 101 when the rotor 112 is driven by the stator 110. In at least one embodiment, the at least one magnet 102 can be attached to the rotor 112. For example, the magnet 102 can be soldered, brazed, peened, rolled, press fitted, adhered, etc., to the rotor 112 of the rotating anode assembly 114. In some embodiments, the at least one magnet 102 can be replaced with (or supplemented with) a ferromagnetic material (e.g., steel or iron), rather than being a permanent magnet. The ferromagnetic material can have different ferromagnetic properties (e.g., different attraction to magnets or magnetic field permittivity) as compared to the materials of the rotor 112 on which the ferromagnetic material is attached.

The sensor 104 can be positioned at the wall 118. In some embodiments, the sensor 104 can be directly coupled to the wall 118. The sensor 104 can be configured to sense a magnetic field of the at least one magnet 102 through the wall 118, such as by being aligned or alignable with the at least one magnet 102 on opposite sides of the wall 118, at least when the magnet 102 rotates or revolves to the position shown in FIG. 1B. In embodiments where the at least one magnet 102 is replaced or supplemented with a ferromagnetic material, the sensor 104 can detect a change in a magnetic flux field (e.g., the field output by the motor/stator) as the ferromagnetic material passes the sensor 104 even if the ferromagnetic material does not output its own significant magnetic field. To avoid repetition herein, references to the at least one magnet 102 will not include additional alternative reference to a ferromagnetic material, but persons having skill in the art and the benefit of the present disclosure will appreciate that the construction of the at least one magnet 102 and operation of the sensor 104 can be achieved using ferromagnetic material wherever there is reference to at least one magnet 102.

The sensor 104 can be configured to be coupled to the wall 118 while occupying a minimal amount of space. The sensor 104 can be cylindrical and can be characterized by a diameter and a length. For example, the sensor 104 can have a diameter of about 6.5 millimeters (mm) and a length of about 30.5 mm. In some examples, the sensor 104 can have a diameter between about 3.5 mm to about 9.5 mm and a length between about 27.5 mm to about 33.5 mm. In some examples, the sensor 104 can be larger or smaller than these listed dimensions. The sensor 104 can have an elongated shape, wherein a length of the sensor (e.g., its longitudinal length) is greater than its width. In some embodiments, the sensor 104 can have a polygonal, rectangular, or square cross-section. The width dimension can be measured across a side or end of the sensor 104 that faces the anode and magnet 102. The elongated length of the sensor 104 can be laterally surrounded by a shield 130 while an end of the shield 130 is longitudinally open toward the at least one magnet 102, as discussed below. The shield 130 can have a bore or inner opening with a shape conforming to the outer surfaces of the sensor 104.

The sensor 104 can comprise an inductive magnetic sensor (e.g., an inductive sensor) configured to generate a current in response to movement of the magnetic field of the at least one magnet 102. The output of the sensor 104 can be monitored to identify changes in the current to detect when the at least one magnet 102 is nearest to the sensor 104. For example, the sensor 104 can be an inductive proximity sensor which can sense a change in current in response to a movement of the magnetic field of the at least one magnet 102. As used herein, an inductive magnetic sensor refers to a device that detects a change in current resulting from a change in magnetic field induced by motion of the at least one magnet 102 past the sensor 104. The sensor 104 can also be referred to as a tubular magnetic field sensor.

In some embodiments, the sensor can be an optical sensor. In this case, the wall 118 may include a window, and the optical sensor can optically detect rotation of the rotating anode assembly 114 by sensing a change in light (e.g., visible, infrared, or UV light) reflected from or generated by the rotating anode assembly 114. In other embodiments, the sensor can be a mechanical sensor. In this case, a mechanical rotary encoder can be attached to the anode 120 or the rotating anode assembly 114 to measure rotation of the rotating anode assembly 114. A vacuum feed-through may be implemented for the insert 108 to allow attachment of the encoder to the rotating anode assembly 114.

While operating the x-ray tube, temperatures of the at least one magnet 102 can approach or exceed 500 degrees Celsius (° C.). Therefore, in some embodiments, the at least one magnet 102 can comprise samarium cobalt (SmCo) or similar magnetic material configured to withstand high temperatures (e.g., about 500 degrees C. or higher) without being demagnetized. In additional or alternative embodiments, the at least one magnet 102 can include other rare earth magnets, such as Neodymium (NdFeB). These types of magnets may be used at lower temperatures compared to SmCo magnets.

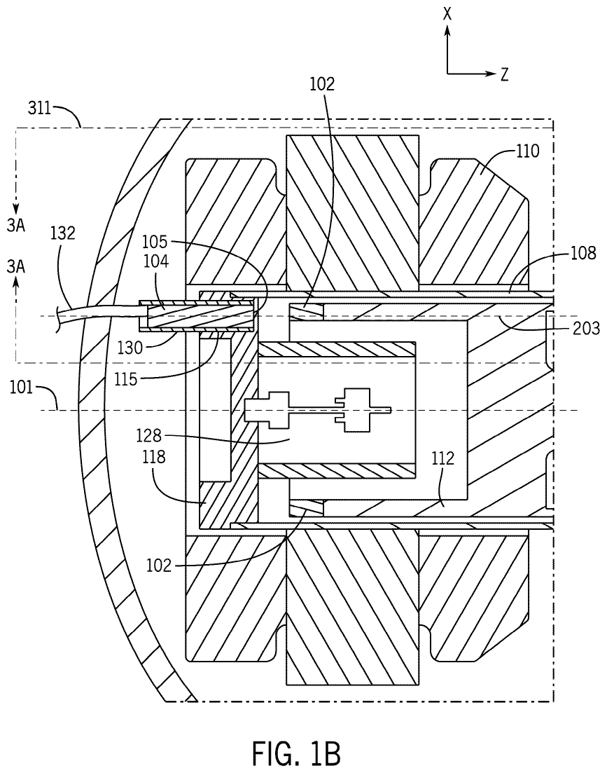

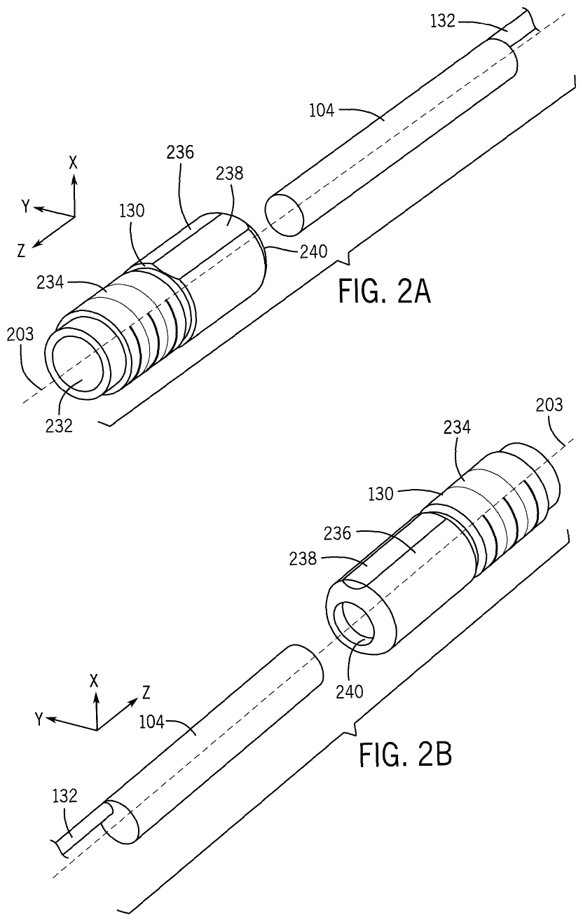

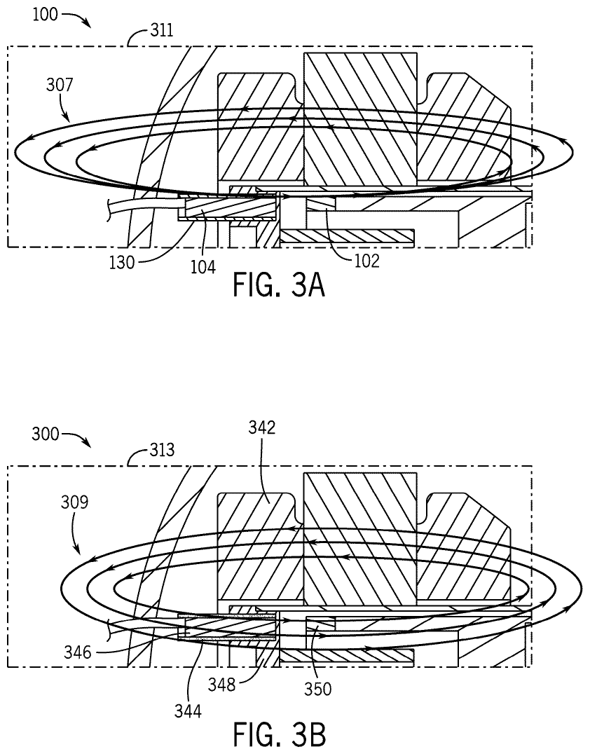

The high magnetic fields emitted from the nearby stator 110 of the x-ray tube 100 can cause noise, artifacts, and other interference with the ability of the sensor 104 to detect the at least one magnet 102. Accordingly, as shown in FIGS. 1A-2B the sensor 104 may be positioned within a shield 130. The shield may be a magnetic shield. The shield 130 may be used to at least partially redirect the magnetic field of the stator 110 to thereby improve sensitivity of the sensor 104, as discussed in further detail below and in connection with FIGS. 3A-4D. The shield 130 can be referred to as a passive shield since the shield 130 can passively mitigate the magnetic field that is sensed by the sensor 104 without needing to be powered or by generating an active magnetic field of its own. In some embodiments, the shield 130 can comprise an active magnetic shielding device, such as, for example, an energizable coil or similar magnetic field generator positioned around the sensor 104 and configurable to shape or redirect the magnetic field of the stator 110 at the sensor 104 to improve the perception of the sensor of the at least one magnet 102 and to reduce the impact of the magnetic field of the stator 110 on the sensor 104.

FIGS. 2A-2B illustrate exploded views of the sensor 104 and a shield 130 of the x-ray tube 100 of FIGS. 1A-1B. The shield 130 and the sensor 104 are coupled to the wall 118 and disposed proximate to the stator 110. The shield 130 and the sensor 104 can be retained to the wall 118 by screws (e.g., set screws), threads on the shield 130, pins, adhesives, press-fitting into drilled holes, welding, similar attachment methods, or combinations thereof. Retention mechanisms such as screws and set screws can allow the shield 130 and/or the sensor 104 to be easily removed and changed. The shield 130 can also be referred to as a retention device which couples to the wall 118. In some embodiments, the shield 130 can retain the sensor 104 to the wall 118, such as by the sensor 104 being press fit or friction fit within the shield 130 and by the shield 130 being threaded or otherwise affixed to an opening 115 in the wall 118.

Furthermore, the shield 130 and the sensor 104 are retained on an outer side of the wall 118 (e.g., opposite the vacuum side of the insert 108). Thus, the wall 118 may include a thin portion of material separating the sensor 104 and shield 130 from the vacuum chamber within the insert 108. In this manner, the vacuum can be more easily maintained because the sensor 104 is not required to extend through a through hole (and potential leak point) in the wall 118. The wall 118 may also comprise a material substantially transparent to magnetic fields, such as a non-ferromagnetic metal material, in order to enhance sensitivity of the sensor 104 through the wall 118.

The shield 130 can include a high-permeability material that substantially limits or redirects stator magnetic fields at the sensor 104 from interfering with pulses corresponding to magnetic fields sensed from the at least one magnet 102. For example, the shield 130 can substantially attract, concentrate, and deflect the stator's magnetic field through the shield 130 so that the stator's magnetic field has less influence on the sensor 104.

In some embodiments, the shield 130 can have a relative permeability of greater than or equal to 15,000. In some examples, the shield 130 can have a relative permeability of between about 8,000 and about 100,000. In some examples, the shield 130 can comprise a material including at least one of: mu-metal, nanoperm, permalloy, metaglas or 99.95% pure hydrogen-annealed iron. As used herein, a “mu-metal” refers to a nickel-iron ferromagnetic alloy. A mu-metal can have an approximate composition including 77% nickel, 16% iron, 5% copper, and 2% chromium or molybdenum. Alternatively, mu-metals can have compositions of approximately 80% nickel, 5% molybdenum, 12-15% iron, and up to 3% of other elements such as silicone. Mu-metals can include variations of the above-listed compositions, such as percentages which differ by up to 5-10% for each element. In some embodiments, the shield 130 can additionally or alternatively include other high-permeability materials, such as iron, iron-based alloys (NANOPERM®), nickel-iron magnetic alloy (permalloy), metal/glass combinations (METAGLAS®), magnetic metal powder (Sendust), high nickel content alloy (Amumetal), high nickel-iron alloy (Hipernom, NILOMAG®), super mu-metal, supermalloy, related materials, or combinations thereof.

The shield 130 can at least partially surround the sensor 104. A portion of the shield 130 can be open toward the anode. As shown, for example, in FIG. 2A, the shield 130 can have opening 232 (i.e., a bore) through which the sensor can detect the magnetic field(s) from the at least one magnet 102 in one direction while the thickness of the rest of the shield 130 limits penetration of the stator's magnetic field from the sides of the sensor 104. Thus, in one embodiment, the shield 130 can be positioned around the sensor 104.

As shown in FIGS. 1B-2B, the sensor 104 may have a longitudinal axis 203. The longitudinal axis 203 can be aligned or alignable with the at least one magnet 102 through the wall 118. In other words, the sensor 104 can be positioned at the wall 118 with an end of the sensor 104 and the opening 232 aligned or alignable with the at least one magnet 102. The longitudinal axis 203 corresponds to a line which runs centrally through the sensor 104 (e.g., through an axis of symmetry of the sensor 104) and substantially parallel to the z-axis. The sensor 104 and the shield 130 can be lengthwise aligned parallel with the axis of rotation 101 (e.g., along the z-axis depicted in FIGS. 1A-1B).

FIGS. 2A-2B show how a length portion of the shield 130 can include a threaded portion 234. The threaded portion 234 can be threaded to and engaged to a threaded opening 115 of the wall 118 to secure the shield 130 to the wall 118. As such, the shield 130 can also secure the sensor 104 to the wall.

The shield 130 can also include a second length portion that may be referred to as a tensioning portion 236. The tensioning portion 236 may be a portion of the shield 130 including traction features 238 by which the shield 130 may be gripped by a user or tool to tighten the shield 130 in place in the wall 118. For example, as depicted in FIGS. 2A-2B, the traction feature(s) 238 can include a flattened surface portion, while the remainder of the tensioning portion 236 may have a rounded or circular surface profile. In some examples, the traction feature(s) 238 can include more than one flattened portions. In some examples, other traction features(s) can include knurling, ridges, protrusions, a polygonal (e.g., hexagonal) pattern, related features, or combinations thereof.

The shield 130 can include an outer opening 240. The outer opening 240 can allow for a wire 132 of the sensor 104 to be electrically and/or communicatively coupled to various electronic modules or components, such as a power source, a computer, etc. In some embodiments, a lip or ridge can be formed at the outer opening 240 that reduces the diameter of the outer opening 240 relative to the bore through the shield 130 and thereby prevents insertion of the sensor 104 into the bore via the outer opening 240 side of the bore. Instead, the wire 132 and the body of the sensor 104 can be inserted through the opening 140 from the opposite end of the bore, i.e., the end adjacent to threaded portion 234.

FIG. 3A schematically illustrates a stator magnetic field 307 (generated by the stator 110) in a sensor region 311 (see FIG. 1B) of the x-ray tube 100 with the shield 130 in place. The stator magnetic field 307 is represented by conventional field line arrows. As depicted in FIG. 3A, the shield 130 can redirect the magnetic field 307 to pass primarily or entirely through the shield 130 instead of passing through the sensor 104. As such, the sensor 104 can detect the magnetic field of the at least one magnet 102 (not illustrated) more clearly than if the stator magnetic field 307 were passing through the sensor 104.

By comparison, FIG. 3B illustrates an alternative configuration where the shield 130 is incapable of, or poorly, redirects a magnetic field from a nearby stator. For instance, stator magnetic field 309 from a similar stator 342 is shown passing through a similar sensor region 313 of a similar x-ray tube 300. X-ray tube 300 can include a retention device 344 (e.g., a shroud, bracket, clamp, or fitting) instead of the shield 130. The retention device 344 can include a material having low permeability (e.g., a relative permeability of less than 15,000). The retention device 344 can be configured to secure a similar inductive sensor 346 to a similar wall 348. However, due to the low permeability of the retention device 344, the retention device 344 may not be configured to shield the stator magnetic field 309 from penetrating the retention device 344, thereby significantly influencing the signal of the sensor 346. As such, the sensor 346 inseparably detects the stator magnetic flux 309 in addition to a magnet magnetic flux due to a magnet 350 on the rotor. The practical impact of the shield 130 on the signals of the sensor 104 as compared to a retention device similar to low-permeability retention device 344 (or no retention device at all) is explained in further detail below. Accordingly, incorporating a shield 130 can improve signal quality and fidelity by substantially blocking the influence on the sensor signal caused by the magnetic field of the stator (e.g., reducing noise and other aberrations).

While the x-ray tube 100 is operated, the at least one magnet 102 can periodically move past the sensor 104 as it rotates with the rotating anode assembly 114. The sensor 104 can be configured to operate within frequency ranges required to detect the at least one magnet 102 as the at least one magnet 102 moves past the sensor 104 at full operating velocity. A current measured by the sensor 104 can change from a baseline value each time the at least one magnet 102 comes in proximity to the sensor 104 during rotation of the rotating anode assembly 114. As shown in FIG. 4A, when there is no noise or other signal interference, the sensor 104 can generate a clear, periodic signal with changes (e.g., voltage drops) that indicate when at least one magnet 102 passes the sensor 104. To achieve this, in some embodiments, a maximum distance between the inward-facing tip of the sensor 104 exposed to the wall 118 and the corresponding outward-facing outer tip of the magnet 102 (e.g., as measured along the Z-direction when the sensor 104 and the magnet 102 are aligned in the position of FIG. 1B) can be between about 0.0375 inches to about 0.4000 inches.

As used herein, a change in current measured by the sensor 104 that exceeds a threshold value can be referred to as a “pulse” or a “current spike.” The threshold value can help filter out fluctuations of the measured sensor value from the baseline due to noise, such as, for example, resulting from thermal noise, shot noise, other intrinsic noise sources, other extrinsic sources, similar factors, or combinations thereof. A frequency of the occurrences of pulses can be used to determine or characterize a speed of rotation of the rotating anode assembly 114. For example, in the case that the rotating anode assembly 114 includes one magnet 102, the frequency of the pulses corresponds to the frequency of rotation (e.g., a rotation speed of 200 Hertz (Hz) corresponds to a pulse frequency of 200 Hz or a periodicity of 0.005 seconds(s)). In the case that the rotating anode assembly 114 includes two magnets 102, the frequency of the pulses corresponds to twice the frequency of rotations (e.g., a rotation speed of 200 Hz corresponds to a pulse frequency of 400 Hz or a periodicity of 0.0025 s). FIG. 4A illustrates a signal 400a including a baseline 452a and pulses 454a resulting from a magnet periodically passing the sensor 104. A change in current at the sensor 104 can be converted to a voltage change for sensor monitoring purposes. For convenience, the present disclosure interchangeably refers to a change in current caused by sensing the movement of the at least one magnet 102 and a change in voltage caused by sensing the movement of the at least one magnet 102.

FIG. 4B illustrates a signal 400b including a baseline 452b and pulses 454b resulting from an anode rotation measurement of the x-ray tube 300 of FIG. 3B, where the retention device 344 provides little or no shielding of the sensor 346 from the magnetic field 309 of the stator 342.

When signal 400b is generated, the rotating anode assembly of the x-ray tube 300 rotates at the same rate as the rotating anode assembly 114 used to generate signal 400a, so the magnet 350 passes the sensor 346 at the same frequency, but the signal 400b includes pulses 454b which occur at irregular intervals, and the signal 400b fails to indicate many missing pulses as compared to signal 400a. The irregularity and missing pulses are caused by noise and other artifacts introduced by the magnetic field 309 of stator 342. Thus, signal 400b represents a superposition of a first signal due to the magnetic field of the magnet 350 (e.g., a desired signal/clean signal 400a) and a second signal due to the magnetic field 309 of the stator 342 (e.g., a noise signal). Additionally, the baseline 452b includes various noise sources (intrinsic and extrinsic) which may be inherent to any anode rotation measurement. Thus, signal 400b would be unreliable for detecting and tracking rotation of the rotating anode assembly.

Introduction of a high-permeability shield (e.g., shield 130) can significantly reduce noise and artifacts from nearby magnetic fields. For example, FIG. 4C illustrates a signal 400c including a baseline 452c and pulses 454c resulting from an anode rotation measurement of the x-ray tube 100 of FIGS. 1A-1B. As described above, the x-ray tube 100 includes shield 130 that shields the sensor 104 from the magnetic field 307 of the stator 110. In signal 400c, the pulses 454c correspond to the at least one magnet 102 passing the sensor 104. The pulses 454c can occur at regular intervals (e.g., the temporally evenly spaced apart pulses in the signal 400c) corresponding to a rotation rate of the rotating anode assembly 114. The baseline 452c can still include noise and artifacts from various noise sources. In some cases, the baseline 452c can include some noise from the magnetic field 307 from the stator 110, even in the presence of the shield 130. However, as shown in signal 400c, the shield 130 redirects or filters enough of the stator's magnetic field to enable consistent detection of pulses 454c.

In the example depicted in FIG. 4C, the shield 130 has a first thickness. For example, the first thickness can be 0.010 inch (in). In other examples, the first thickness can be between 0.005 in and 0.020 in. FIG. 4D illustrates a signal 400d including a baseline 452d and pulses 454d resulting from an anode rotation measurement of the x-ray tube 100 of FIGS. 1A-1B, but with a different, increased, shield thickness compared to the shield thickness of FIG. 4C. The pulses 454d can occur at substantially regular intervals (temporally evenly spaced apart pulses in the signal 400d) corresponding to a rotation speed of the rotating anode assembly 114. For example, as depicted in FIG. 4D, the shield can have a second thickness. The second thickness can be about 0.030 in. In other examples, the second thickness can be between about 0.021 in and about 0.060 in. In other examples, the second thickness can be greater than about 0.040 in.

As indicated in signals 400c and 400d, a thicker shield 130 can reduce noise, signal dropouts and irregularities, and other outside influences to produce a cleaner and clearer rotation detection signal, due to the magnetic field of the stator 110 being more effectively prevented from passing into the sensor 104. Signal clarity can be optimized by selecting a shield thickness which effectively deflects the stator magnetic field without being overly expensive or large. Signals can also be tuned based on which high-permeability materials are used in the shield 130.

The amplitude of noise fluctuations of the baselines (e.g., the baselines 452c and 452d) can depend on the thickness of the shield. Similarly, and although relative voltage scales are not indicated, the amplitude of the pulses (e.g., the pulses 454c and 454d) can depend on the thickness of the shield. The period of the signal (e.g., the signal 400c and 400d) (e.g., the time or distance) between adjacent pulses can represent each time the at least one magnet 102 passes the shield 130. The period (which can be averaged when necessary due to noise conditions) can correspond to a rotation frequency of the rotating anode assembly 114 and the anode. As described below with reference to FIGS. 5A-5B, the frequency of the pulses in the signal (e.g., 400c or 400d) can depend on the number and spacing of magnets on the anode in addition to the rotation frequency of the anode.

In some embodiments, fluctuations of the baselines and other sources of noise can be computationally reduced, such as by methods such as autocorrelation.

In FIGS. 4A-4D, the signals 400a-400d are represented as voltage pulses as a function of time. In other examples, the signals can be represented as current pulses as a function of time. The signal 400a can be representative of a magnet which revolves ideally about an axis of rotation such that passes the sensor periodically. The signal 400a includes a plurality of temporally spaced apart pulses. As used herein, “revolves ideally” refers to a situation in which the sensor measures a signal from only the magnet and not from other sources (such as a stator or other extrinsic magnetic field). Further, the signal 400a represents an ideal signal in which no other noise sources (both intrinsic and extrinsic) are present. Thus, the signal 400a can represent a clean measurement in which the pulses are temporally equally spaced.

FIG. 5A illustrates an end view of a rotating anode assembly 514a of an x-ray tube. The “end view” refers to a view in which the rotating anode assembly 514a is viewed along the z-axis. Although not all components are shown, the rotating anode assembly 514a can be similar to the rotating anode assembly 114 of FIG. 1. Rotating anode assembly 514a illustrates various configurations of the magnet(s) coupled to a rotor 512a of the rotating anode assembly 514a.

In one embodiment, the rotating anode assembly 514a can include one magnet 502 and one counterweight 558. The counterweight 558a can be configured to balance a distribution of weight about the perimeter of the rotor 512a on opposite sides of the axis of rotation of the rotor 512a to allow the rotor 512a and the rotating anode assembly 514a to rotate smoothly at high velocities. The counterweight 558a can be disposed directly opposite the magnet 502 along a diameter of the rotor 512a. The counterweight 558a can be configured to have a mass that is equal to a mass of the magnet 502. Further, the counterweight 558a can comprise a non-magnetic material or a material having equal or different magnetic strength from the magnet 502. Thus, in some cases, the counterweight 558a (or other counterweights, as explained below) can be referred to as additional magnets forming a plurality or set of magnets of the at least one magnet 102 of the x-ray tube 100.

In a further embodiment, the rotating anode assembly 514a can include additional counterweights (e.g., a pair of counterweights), e.g., including a second counterweight 558b and a third counterweight 558c, which are shown in broken lines to indicate optionality. The magnet 502, the first counterweight 558a, the second counterweight 558b, and the third counterweight 558c can be disposed at evenly spaced intervals about the circumference of the rotor 512a. The second counterweight 558b can be disposed halfway between (e.g., 90° from either of the) the magnet 502 and the first counterweight 558a. The third counterweight 558b can be disposed halfway between magnet 502 and the first counterweight 558a, and opposite the second counterweight 558b along the diameter of the rotor 512a. In this embodiment, any of the first, second, or third counterweights can be magnetic or non-magnetic.

In a further embodiment (not illustrated), the rotating anode can include additional pairs of counterweights 558 that are evenly spaced about the circumference of the rotor 512a. Any of the counterweights 558 can be either magnetic or non-magnetic, but each of the counterweights 558 can have a mass equal to the mass of the magnet 502. In various cases, the magnet(s) and counterweight(s) can all be equally circumferentially spaced apart from each other.

In cases where one or more of the counterweights 558 are magnetic, anode rotation measurement can be affected. For example, a pulse can be generated at a sensor (e.g., 104) each time a different magnet passes the sensor. Therefore, increasing the number of magnets can increase the frequency of pulses corresponding to one revolution of the rotor 512a. Additionally, varying the pattern of the distribution of magnetic and non-magnetic counterweights can cause the anode rotation measurement signal to have a non-constant frequency. For example, if the rotor 512a has in order: a magnet, a non-magnetic counterweight, a magnetic counterweight, and a non-magnetic counterweight, the pulses may occur at a constant frequency as the rotating anode assembly 514a rotates. On the other hand, if the rotor 512a has in order: a magnet, a magnetic counterweight, a non-magnetic counterweight, and a non-magnetic counterweight, one revolution of the rotating anode assembly 514a can include two adjacent pulses during half of the revolution and no pulses during the other half of the revolution. Accordingly, the frequency of rotation of the rotor 512a can be represented by a series of equal-magnitude and equally-spaced-apart pulses, variable-magnitude and equally-spaced-apart pulses, equal-magnitude and variably-spaced-apart pulses, or variable-magnitude and variably-spaced-apart pulses. The series of pulses and their related magnitudes can be interpreted to enable detection of the direction of rotation of the rotor. For example, a first signal pulse followed by a relatively smaller second signal pulse that is then followed by no pulse can indicate that the rotor is turning with the stronger magnet followed by a smaller magnet and then a counterweight.

FIG. 5B illustrates an end view of another embodiment of a rotating anode assembly 514b of an x-ray tube. Although not all components are shown, the rotating anode assembly 514a can be similar to the rotating anode assembly 114 of FIGS. 1 and 514a of FIG. 5A, except that the rotating anode assembly 514b can include a different configuration of at least one magnet(s) 502 coupled to a rotor 512b of the rotating anode assembly 514b. The rotating anode assembly 514b may optionally include counterweight(s) coupled to the rotor 514b. In particular, the rotating anode assembly 514a includes the magnet 502 and an odd number of counterweight(s) 558a, 558b, etc., while the rotating anode assembly 514b includes the magnet 502 and an even number of counterweights(s) 560. The counterweights 560 can have similar properties to the counterweight(s) 558.

In one embodiment, the rotating anode assembly 514b can include a first counterweight 558a and a second counterweight 558b. The magnet 502, the first counterweight 558a and the second counterweight 558b can be disposed at evenly spaced intervals about the circumference of the rotor 512b. In other terms, each of the magnet 502, the first counterweight 558a, and the second counterweight 558b can be separated by an angle of 120 degrees.

In a further embodiment, the rotating anode assembly 514b can include a third counterweight and a fourth counterweight. The magnet 502, the first, second, third, and fourth counterweights can be disposed at evenly spaced intervals about the circumference of the rotor 512b. In other terms, each of the magnet 502 and the first, second, third, and fourth counterweights can be separated by an angle of 72 degrees.

Thus, the magnet (e.g., the magnet 102 or the magnet 502) and any counterweights can be evenly spaced about the circumference by an angle equal to 360 degrees divided by n+1 where n refers to the total number of counterweights.

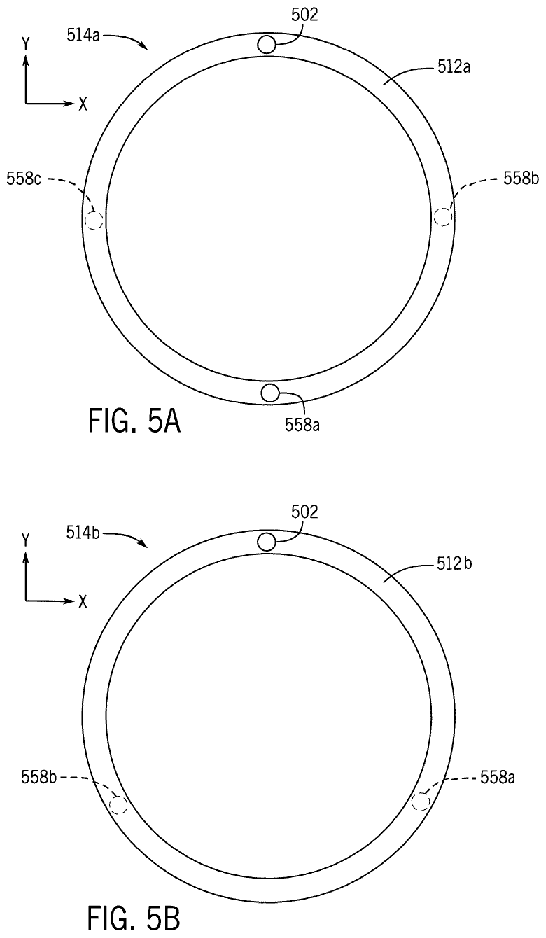

FIG. 6 illustrates a method 600 for detecting rotation of an anode (e.g., 120 in an x-ray tube 100 corresponding to the embodiments discussed herein. The method 600 may include providing a sensor 104 at a wall 118 of an enclosure (e.g., insert 108) of the x-ray tube 100, as indicated in block 602. The wall 118 can be positioned at an opposite end of the anode 120 relative to a cathode assembly 122 of the x-ray tube 100.

The sensor 104 can be directly coupled to the wall 118. Positioning the sensor 104 at the wall 118 can include positioning the sensor 104 with an end of the sensor 104 aligned or alignable with the at least one magnet 102. A longitudinal axis of the sensor 104 can be alignable with the at least one magnet 102 through the wall 118. The sensor 104 can be entirely external to the wall 118, i.e., a solid portion of the wall 118 can be positioned between the anode-facing end of the sensor 104 and the anode 120. In some embodiments, the sensor 104 is provided at the wall 118 by adhesive, fasteners, a press-fit, welding, similar attachment methods, and combinations thereof.

The at least one magnet 102 can be positioned at an outer perimeter of the anode 120 relative to the axis of rotation 101 of the anode 120, as discussed in connection with FIGS. 5A and 5B. The at least one magnet can include at least two magnets circumferentially spaced around an outer perimeter of the anode 120.

A shield 130 can be configured to surround the sensor 104. A portion of the shield can open toward the anode 120. The shield 130 can be or include a retaining device or retention mechanism (e.g., threads, interlocking parts, similar structures, and combinations thereof) to retain the sensor 104 to the wall 118. The shield 130 can have a relative permeability of greater than or equal to 15,000. The shield 130 can comprise a material including at least one of mu-metal, nanoperm, permalloy, metaglas, or 99.95% pure hydrogen-annealed iron.

The method 600 can include rotating an anode 120 within the enclosure 106, as indicated in block 604. The anode 120 can be drivable by a stator 110 to rotate via induction. The stator 110 can be positioned external to the wall 118 and insert 108. The at least one magnet 102 can be positioned on the anode 120 and can rotate with the anode 120 about an axis of rotation 101 of the anode. In some embodiments, the anode 120 can be rotated by a different type of motor, such as a brushed electric motor, a driveshaft extending into the insert 108, or similar.

The method 600 can include providing at least one magnet 102 on the anode 120, as in block 606. The at least one magnet 102 can be rotatable with the anode 120 about an axis of rotation 101 of the anode 120. In some embodiments, providing the magnet on the anode can include attaching the magnet to the anode, such as by attachment methods discussed elsewhere herein (e.g., adhesive, welding, press fit, threads, interference fit, interlocking parts, etc.).

The method 600 can further include detecting a change in a signal (e.g., 400a-400d) produced by the sensor 104 in response to a movement of a magnetic field of the at least one magnet 102 as the anode 120 rotates within the wall 118 of the enclosure 106, as indicated in block 608. The sensor 104 can comprise an inductive sensor configured to sense a change in current. The change in current can be responsive to movement of the magnetic field of the at least one magnet. Detecting the change in the signal 400 can include detecting a plurality of temporally spaced apart pulses in the signal, as discussed in connection with FIGS. 4A-4D.

In at least one embodiment, the method 600 can include positioning a shield 130 around the sensor 104. The shield 130 can be configured to redirect a second magnetic field from the sensor 104. The shield can be positioned around a cylindrical body of the sensor while also not covering an end of the sensor, as discussed above. The shield can have high permittivity, as discussed above.

Accordingly, aspects of the present disclosure relate to systems, apparatuses, and methods for inductively measuring anode rotation speeds. Anode rotation speed measurements can provide information regarding an operational and/or usage status of an x-ray tube. For example, an anode rotation speed measurement can provide a prediction or an indication of a remaining lifetime of a bearing assembly 162 of the x-ray tube 100 about which the anode rotating anode assembly 114 rotates. Additionally, anode rotation speed measurements can provide an indication of whether or not the x-ray tube 100 is malfunctioning or is being misused. These aspects are discussed in more detail below.

During rotation of a rotating anode assembly (e.g., 114), bearings (e.g., 164) of a bearing assembly (e.g., 162) can wear out, whether by simply being used for an extended period of their service life, due to malfunctioning, or due to misuse of the x-ray tube 100. Predicting when the x-ray tube 100 may fail can allow users or service/warranty providers to schedule replacements or repairs prior to failure of the x-ray tube. Further, users may be able to tell if the x-ray tube is operating inefficiently due to increased friction associated with worn out bearings. For example, worn out bearings 164 can lead to motor slipping and friction within the motor and/or moving components of the x-ray tube.

Additionally or alternatively, by monitoring the anode rotation speed, the power provided to drive the rotating anode assembly 114 can be adjusted to drive the rotating anode assembly 114 at an appropriate or desired speed. In some embodiments, the anode rotation rate measurements can be correlated to the input power provided to the motor (e.g., 110/112) to estimate the amount of friction or similar resistance provided by the bearing assembly 162. As friction increases, the likelihood of bearing or anode assembly failure can increase. Input power may need to increase to compensate for drag in the bearing assembly. Thus, the efficiency of the system may drop due to additional power being needed to accelerate or maintain the rotation speed of the anode assembly.

Additionally, if anode rotation speed is too low, excessive heat from the electron beam can damage or degrade the target 124 and anode 120. Therefore, the rate of rotation of the rotating anode assembly can be tracked to ensure sufficient velocity of the target 124 is reached before a signal to generate x-rays is provided to the x-ray tube 100. The tracking can also be used for product quality assurance or to monitor usage cycles or misuse of the x-ray tube.

In at least one embodiment, an x-ray assembly or x-ray tube 100 can include a rotatable anode assembly 114. An anode 120 is drivable by a stator 110 to rotate about an axis of rotation 101. At least one magnet 102 is positioned on and rotatable with the anode 120 about the axis of rotation 101.

In one embodiment, the x-ray assembly further comprises an enclosure 106 including a wall 118, wherein the anode 120 is positioned within the wall 118, a stator 110 positioned external to the wall 118, and a sensor 104 configured to sense a magnetic field of the at least one magnet 102 through the wall 118.

In one embodiment, the sensor 104 is directly coupled to the wall 118. In one embodiment, the x-ray tube 100 includes a shield 130 surrounding the sensor 104. A portion 105 of the shield 130 is open toward the anode 120. In a further embodiment, the shield 130 has a relative permeability of greater than or equal to 15,000. In a further embodiment, the shield 130 is a material including at least one of: mu-metal, nanoperm, permalloy, metaglas, or 99.95% pure hydrogen-annealed iron.

In one embodiment, the wall 118 is positioned at an opposite end of the rotating anode assembly 114 relative to a cathode 122 of the x-ray tube 100.

In one embodiment, the at least one magnet 102 is positioned at an outer perimeter of the anode 120 relative to the axis of rotation 101.

In one embodiment, the at least one magnet 102 includes at least two magnets circumferentially spaced around an outer perimeter of the anode 120.

In one embodiment, a longitudinal axis of the sensor 104 is alignable with the at least one magnet 102 through the wall 118.

In one embodiment, the sensor 104 is an inductive magnetic sensor configured to sense a change in current in response to movement of the magnetic field of the at least one magnet 102.

In at least one embodiment, a method of detecting rotation of an anode 120 in an x-ray tube 100 includes providing a sensor 104 at a wall 118 of an enclosure 106. The method includes rotating the anode 120 within the enclosure 106 of the x-ray tube 100. The method includes providing at least one magnet 102 on the anode. The at least one magnet 102 is rotatable with the anode 120 about an axis of rotation 101 of the anode 120. The method includes detecting a change in a signal 400 produced by the sensor 104 in response to movement of a magnetic field of the at least one magnet 102 as the anode 120 rotates within the wall 118 of the enclosure.

In one embodiment, positioning the sensor 104 at the wall 118 includes positioning the sensor 104 with an end of the sensor 104 aligned with the at least one magnet 102.

In one embodiment, the method further includes positioning a shield 130 around the sensor 104. The shield 130 is configured to redirect a second magnetic field 307/309 from the sensor 104.

In one embodiment, detecting the change in the signal 400 includes detecting a plurality of temporally spaced apart pulses in the signal.

In one embodiment, the sensor 104 is an inductive sensor configured to sense a change in current.

In at least one embodiment, an x-ray tube 100 includes a means for sensing a position of an object (magnet 102) within a wall 118 of an enclosure 106. The x-ray tube 100 can include a means for generating x-rays from an electron beam within the enclosure 106. The means for generating x-rays is configured to rotate the object (magnet 102) about an axis of rotation 101 within the wall 118 of the enclosure 106 as the x-rays are generated. The means for sensing is configured to detect rotation of the object within the wall 118 of the enclosure 106.

In one embodiment, the object is a magnet 102. The means for sensing the position of the object includes a sensor 104, a magnetic sensor, a magnetic inductive sensor, or an inductive sensor.

In one embodiment, the means for generating x-rays includes a cathode 122 and a rotatable anode 120 or a rotatable anode assembly 114.

In one embodiment, the object is positioned on the rotatable anode 120.

In one embodiment, the x-ray tube 100 further includes a means for shielding the means for sensing from a magnetic field. The means for shield can include a high-permeability retention device. The high-permeability retention device can include at least one of: mu-metal, nanoperm, permalloy, metaglas, or 99.95% pure hydrogen-annealed iron.

In at least one embodiment, an x-ray tube 100 includes a means for sensing a position of an object, such as a magnet 102, within a wall 118 of an enclosure 106. The x-ray tube 100 includes a means for generating x-rays from an electron beam within the enclosure 106. The means for generating x-rays is configured to rotate the object (magnet 102) about an axis of rotation 101 within the wall 118 of the enclosure 106 as x-rays are generated. The means for sensing is configured to detect rotation of the object (magnet 102) within the wall 118 of the enclosure 106.

In one embodiment, the object is the magnet 102. The means for sensing the position of the object includes a magnetic sensor, such as the sensor 104.

In one embodiment, the means for generating x-rays includes a cathode 122 and a rotatable anode 120. The means for generating x-rays can also include a rotatable anode assembly 114.

In one embodiment, the object (magnet 102) is positioned on the rotatable anode 120.

In one embodiment, the x-ray tube 100 includes a means for shielding the means for sensing from the magnetic field. The means for shielding can include the shield 130, which can shield the magnetic sensor 104 from the magnetic field 307 of the stator 110.

Another aspect of the present disclosure relates to an x-ray tube assembly, comprising: an insert, a stator positioned around the insert, a magnetic sensor including an end facing toward an interior of the insert and the stator, and a magnetic shield surrounding the magnetic sensor and being open at the end facing toward the interior of the insert.

In some embodiments, the x-ray tube assembly further comprises an anode assembly including a rotor positioned within and rotatable relative to the stator and at least one magnetic rotatable with the rotor, and wherein the sensor is configured to sense the magnetic field of the at least one magnet.

In one embodiment, the sensor comprises an elongated shape having an elongated length surrounded by the magnetic shield.

In one embodiment, the magnetic shield comprises a material having a relative permeability about 8,000 or more.

In one embodiment, the insert further comprises a wall, the at least one magnet being positioned within the wall, and the magnetic sensor being positioned on or outside the wall.

In one embodiment, the at least one magnet comprises at least two magnets positioned spaced apart on the rotor, wherein the at least two magnets are movable past the magnetic sensor as the rotor rotates relative to the stator.

Anode rotation speed measurements can be used to create bearing lifetime predictions and to detect rotor slip. As discussed above, over prolonged use of the x-ray tube, the bearings of the bearing assembly can wear down and can cause inefficient operation and/or failure of the x-ray tube. Embodiments described herein relate to using an anode speed rotation measurement as a feedback parameter to adjust the power provided by an anode driver to the stator of the motor to compensate for rotor slip.

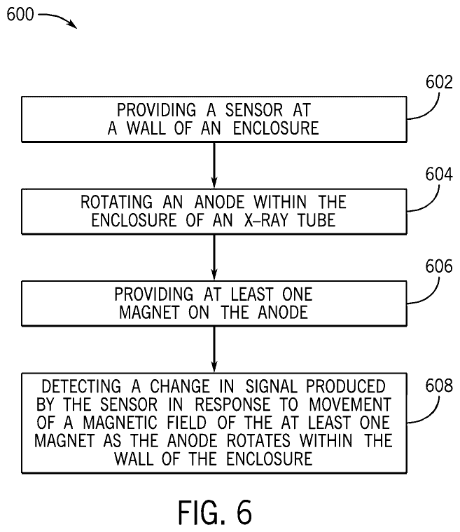

FIG. 7 illustrates a schematic diagram of an x-ray assembly 700 including an x-ray tube (e.g., 100) and an anode rotation sensor 768. Although some components are not shown and some additional components are shown schematically, the x-ray tube described with respect to FIG. 7 can be the same as or similar to the x-ray tube 100 of FIG. 1.

The x-ray tube 100 can include the anode rotation sensor 768 (e.g., 104) and an electric motor 766. The electric motor 766 can include the stator 110 and the rotatable anode assembly 114. The rotatable anode assembly 114 can include a bearing 164 usable to guide rotation of the rotatable anode assembly 114.

The anode rotation sensor 768 can include a magnetic sensor 104 configured to detect a magnetic field generated by a magnetic element rotatable with the rotatable anode assembly 114. The magnetic element can be the same as or similar to the magnet 102.

The anode rotation sensor 768 can also include a shield, such as the shield 130 configured to shield the magnetic sensor 104 from a magnetic field of the stator 110. The anode rotation sensor 768 can be operable to generate a signal corresponding to a rate of rotation of the rotatable anode assembly 114. For example, the signal includes a series of pulses corresponding to a frequency of rotation of the rotatable anode assembly 114 within the x-ray tube 100.

The x-ray assembly 700 can include an anode driver 770. The anode driver 770 can be referred to as a generator, a motor drive, or a motor driver. The anode driver 770 can be operable to drive the electric motor 766, such as by providing current to the stator 110. In various embodiments, the anode driver 770 can comprise a physical power generator that is part of the x-ray tube 100, or the anode driver 770 can be a separate device from the x-ray tube 100.

The x-ray assembly 700 may also include a power monitoring sensor 772 operable to determine at least one power property provided to the electric motor 766 from the anode driver 770. The sensor 772 can be connected to, or include, a voltage divider 784 and/or a current sensor 786 for tracking the power provided to the x-ray tube 100.

The x-ray assembly 700 includes a processor 778 and a non-transitory computer-readable storage medium (CRM) 750 (e.g., memory such as random access memory (RAM) or other electronic storage device with memory for logging, storing, and retrieving data) having encoded electronic instructions which can be executed by the processor 778.

In one embodiment, the encoded electronic instructions, when executed by the processor 778, cause the processor 778 to determine, via the power monitoring sensor 772, at least one power property provided to the electric motor 766 from the anode driver 770.

In one embodiment, the encoded electronic instructions, when executed by the processor 778, cause the processor 778 to determine, via the anode rotation sensor 768, the rate of rotation of the rotatable anode assembly 114. In one embodiment, the processor 778 can record the rate of rotation and the power provided over time. The power provided to drive rotation of rotatable anode assembly can be a three-phase power.

In one embodiment, the encoded electronic instructions, when executed by the processor 778, may cause the processor 778 to determine an operating characteristic of the rotatable anode assembly 114 based on the power property and the rate of rotation. Determining the operating characteristic can include comparing a rotation frequency of the rotatable anode assembly 114 to a frequency of the three-phase power driving the electric motor 766. In at least one embodiment, the operating characteristic information can include a discrepancy between an expected rate of rotation of the rotatable anode assembly 114 and the actual rate of rotation of the rotatable anode assembly 114. The expected rate of rotation of the rotatable anode assembly 114 can correspond to a calculated rate of rotation based on the power provided. The actual rate of rotation of the rotatable anode assembly 114 corresponds to a measured rate of rotation (e.g., via the sensor 104). In an additional or alternative embodiment, the operating characteristic may include an estimated life span characteristic of the bearing 164.

In one embodiment, the x-ray assembly 700 optionally further includes a temperature sensor 790. The temperature sensor 790 can be configured to measure a temperature within the x-ray tube 100, such as by a thermistor, thermocouple, infrared temperature sensor, thermometer, similar devices, and combinations thereof. The temperature can be measured between the enclosure 106 and the insert 108. In one example, volume between the enclosure 106 and the insert 108 can be filled with an oil or other heat-conductive material, which can provide an indirect measurement of the temperature in proximity to the bearing 164. The estimated life span characteristic of the bearing 164 can be determined at least partially based on the temperature within the x-ray tube 100. Thus, the temperature data can be used in connection with the operating characteristic to calculate an estimated life span characteristic of the bearing 164. Frequent operation at high temperatures can reduce overall life span of the device.

In one embodiment, the x-ray assembly 700 optionally further includes an acceleration sensor 782 (e.g., an accelerometer). The acceleration sensor 782 can be configured to measure an acceleration of the x-ray tube 100 as a whole. A load or a stress on the bearing 164 can be dependent on g-forces experienced by the x-ray tube 100 and the bearing 164 resulting from rotation or movement of a gantry (not depicted) of the x-ray assembly 700 (e.g., a gantry or rotating member of a computed tomography (CT) scanner or similarly movable device). The estimated life span characteristic of the bearing can be determined at least partially based on the acceleration of the x-ray tube 100. For example, frequent high accelerations of the assembly 700 or high G-loads on the assembly 700 (e.g., up to 50G) can used to determine a reduction in the estimated life span.

In one embodiment, the x-ray assembly 700 further includes a power chain controller (PCC) 776. The PCC 776 can be configured to receive a feedback signal from the processor 778 indicating the operating characteristic of the rotatable anode assembly 114. The PCC 776 can be configured to provide a control signal to the anode driver 770 based on the feedback signal. The PCC 776 can be optionally used in x-ray assemblies 700 where the anode driver 770 is not capable of connecting to and responding to signals from a processor 778, thus adapting the anode driver 770 to be controllable by the processor 778.

In one embodiment, the x-ray assembly 700 further includes a tube auxiliary unit (TAU) 774. The TAU 774 may include the power monitoring sensor 772 and, optionally, a voltage divider 784 and/or a current sensor 786. The TAU 774 can be attached to the x-ray tube 100 and can be used to track and control operation of the x-ray tube 100 in conjunction with the processor 778. In some embodiments, the TAU 774 can also include the processor 776, the CRM 750, acceleration sensor 782, and isolator 788.

In one embodiment, the x-ray assembly 700 further includes an isolator 788. The isolator 788 can be configured to electrically isolate the CRM 750, the processor 778, and the acceleration sensor 782 from the x-ray tube 100, the anode driver 770, the TAU 774, and the PCC 776. The isolator 788 can protect components such as the CRM 750, the processor 778, the acceleration sensor 782, and other sensitive electronic components from electrical damage. Electrical damage can include electrical surges, arcing, and presence of high voltages used to power the x-ray tube 100.

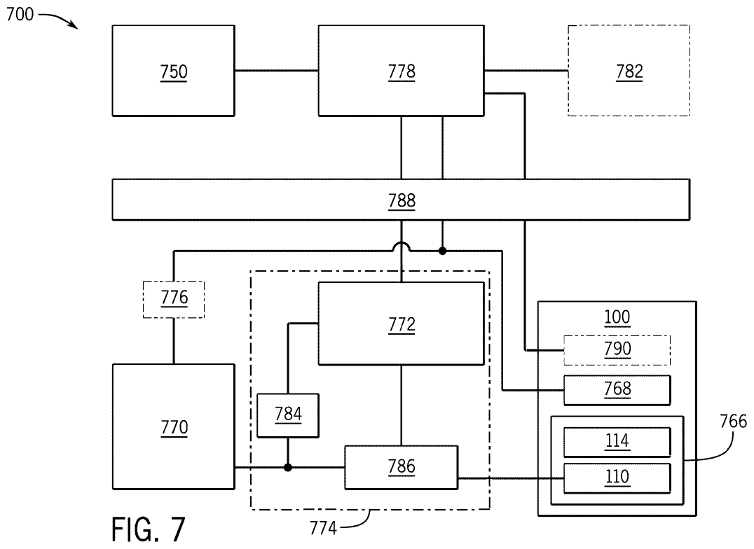

FIG. 8 is a flow chart of a method of an anode rotation speed feedback loop 800 for controlling anode rotation speed. The method can be used with the apparatuses described above, such as x-ray tube 100 and assembly 700. The anode rotation speed feedback loop 800 can be operated by the processor 778 executing the electronic instructions. The processor 778 can implement the anode rotation speed feedback loop 800 to control the x-ray assembly 700 to adjust the rotation speed of the anode 120.

At block 802, the processor 778 can measure the anode speed. The processor 778 can determine, via an anode rotation sensor 104, the rate of rotation of the rotatable anode assembly 114 within the x-ray tube 100, e.g., using techniques described above.

The processor 778 can also determine, via at least one power sensor, such as power sensor 772, power provided to drive rotation of the rotatable anode assembly 114 from the anode driver 770. At block 804, the processor 778 can determine whether the velocity/speed of the rotatable anode assembly 114 is within a predetermined acceptable range of values based on a comparison of the rate of rotation and the power provided. For example, if the speed and power correlate within an acceptable range of predetermined values (e.g., nominal speed to power ratios, such as ratios determined empirically by the producer of the x-ray tube), the processor 778 may indicate that the speed is acceptable and advance to block 802.

Thus, in a first example, the expected rate of rotation and the actual rate of rotation of the anode may be substantially the same. Specifically, the rate of rotation may be within a threshold range of the expected rate of rotation. As used herein, the actual rate of rotation may be substantially the same if it is within 5% or less of the expected rate of rotation. In another example, substantially the same corresponds to the rate of rotation being within 10% or less of the expected rate of rotation. In other examples, substantially the same can refer to other percentages, such as 0%, 3%, 7%, 15%, etc. This case may indicate that the bearing 164 are not yet worn and that the x-ray tube 100 is operating efficiently without significant motor slip. The processor 778 returns to block 802 of the anode rotation speed feedback loop 800.

In a second example, the expected rate of rotation and the rate of rotation may be different. Specifically, the rate of rotation may not be within the threshold value of the expected rate of rotation. This may indicate that the bearing 164 is overly worn and that the anode and/or anode driver may be operating inefficiently or prone to failure. Thus, if the speed and power provided do not correlate within the acceptable predetermined range, e.g., the speed is slower than expected for the presented power, the processor 778 may advance to block 806.

At block 806, the processor 778 (or other component of TAU 774) can adjust operation of the rotatable anode assembly 114 based on the operating characteristic (e.g., the rotation speed of the anode). The processor 778 (or other component of TAU 774) can adjust power provided to drive the rotation of the rotatable anode assembly from the anode driver 770. For example, the processor 778 (or other component of TAU 774) can increase or decrease the power provided to drive the rotation of the rotatable anode assembly 114 from the anode driver 770 until the rate of rotation is within the threshold range of the expected rate of rotation. Thus, increasing or decreasing the power respectively corresponds to increasing or decreasing the rate of anode rotation. The processor 778 then proceeds to block 802 of the anode rotation speed feedback loop 800. Optionally, the processor 778 may produce and transmit an alert signal (e.g., via a user interface or communications interface connected to the processor 778). The alert signal may indicate that speed adjustment action has been taken or that the anode or bearing may be operating beyond expected normal operating conditions (e.g., at lower efficiency or with a slower startup time than expected).

In this manner, the feedback loop 800 can be operated continuously while the x-ray tube 100 is working. By adjusting the speed of the anode when needed, the life span of the x-ray tube 100 may be extended.

In some embodiments, the rate of rotation may optionally be changed in connection with block 806 in response to receiving a signal from a temperature sensor (e.g., 790). If the temperature is too low, the anode speed can be turned down to save energy and bearing life, and if the temperature is too high, the anode speed can be turned up to help distribute heat at the target.

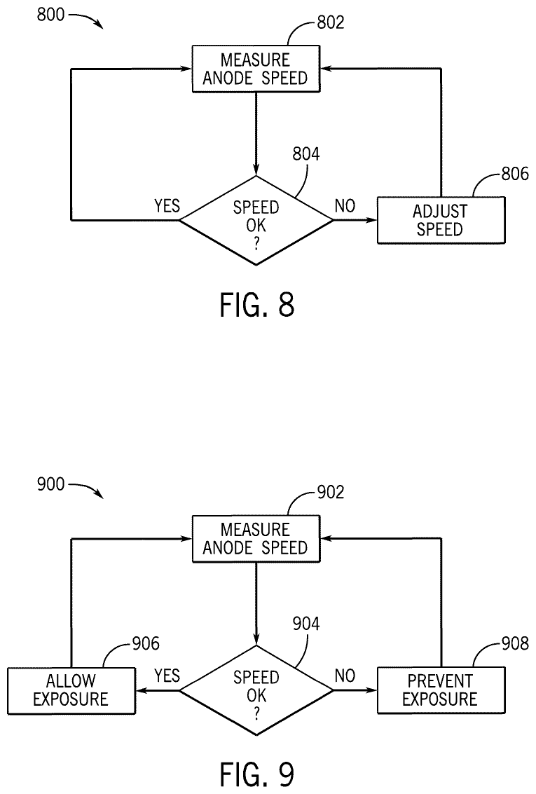

FIG. 9 is a flow chart of a method of an anode rotation speed feedback loop 900 for controlling anode exposure. The anode rotation speed feedback loop 900 can be performed by the processor 778 executing electronic instructions including operating the steps of the feedback loop 900. The processor 778 can implement the anode rotation speed feedback loop 900 to control the x-ray assembly 700 to allow or prevent exposure of the rotatable anode assembly 114 to an electron beam generated by the x-ray tube 100.

The processor 778 can determine the power provided to drive rotation of the rotatable anode assembly 114 from the anode driver 770. To do so, the processor 778 can use signals from the TAU 774, e.g., its power monitoring sensor 772. In embodiments where the processor 778 is part of the TAU 774, the processor 778 may use any signals from any sensors it is connected to therein.

The processor 778 performs the operations of block 902 in FIG. 9 as described with respect to block 902 of FIG. 8, including measuring the speed (or another related operating characteristic) of the anode. The processor 778 then proceeds to block 904.

At block 904, the processor 778 can compare the speed to an expected speed for the provided power. If there is too much of a difference between the expected speed (at the provided power) and the actual speed (at the provided power), the processor 778 can adjust operation of the rotatable anode assembly 114.

In a first example, the actual or measured rate of rotation may be greater than or equal to the expected rate of rotation. In this case, the processor may permit exposure of the anode assembly to generate x-rays without being unusually damaged. The processor thus allows exposure of the rotatable anode assembly 114 to the electron beam generated by the x-ray tube 100. The processor 778 can then return to block 902 of the anode rotation speed feedback loop 900.

In a second example, the actual or measured rate of rotation (at the provided power) may be less than the expected rate of rotation (again based on the provided power). In this case, exposure of the rotating anode assembly 114 to the electron beam can damage the rotating anode assembly 114. The processor 778 can thus prevent exposure of the rotatable anode assembly 114 to the electron beam generated by the x-ray tube 100, as indicated in block 908. In conjunction with operation of feedback loop 800, in some cases, the processor 778 can increase power provided to drive the rotation of the rotatable anode assembly until the rate of rotation is greater than or equal to the expected rate of rotation. The processor 778 may then allow exposure of the rotatable anode assembly 114 to the electron beam generated by the x-ray tube 100. The processor 778 returns to block 902 of feedback loop 900.

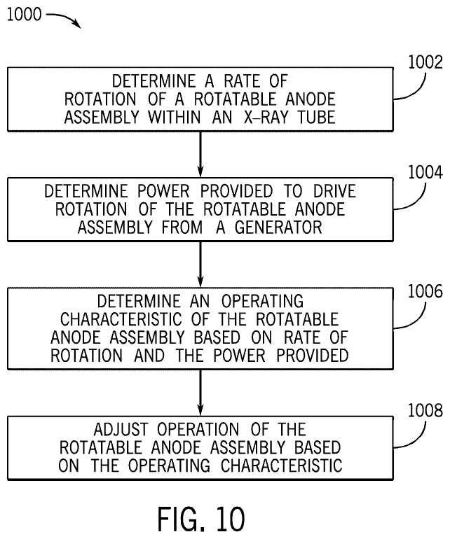

FIG. 10 is a diagram of a method 1000 for controlling an x-ray assembly (e.g., 700 or x-ray tube 100). The method 1000 can include determining, via an anode rotation sensor 768, a rate of rotation of a rotatable anode assembly 114 within an x-ray tube 100, as in block 1002. For example, a processor (e.g., 778) can detect the rate of rotation by tracking the frequency of irregularities in a signal pattern from the anode rotation sensor 768, as discussed above in connection with FIGS. 4A-4D.

The method 1000 can also include determining, via at least one power sensor 772, power provided to drive rotation of the rotatable anode assembly 114 from an anode driver 770, as indicated in block 1004. For example, a processor can detect or determine power output from a signal of the power monitoring sensor 772 or other sensor signal of the TAU 774.

The method 1000 can include determining an operating characteristic of the rotatable anode assembly 114 based on the rate of rotation and the power provided, as in block 1006. In one embodiment, the operating characteristic includes a discrepancy between an expected rate of rotation of the rotatable anode assembly 114 and the actual or measured rate of rotation of the rotatable anode assembly 114.

The method 1000 can include adjusting operation of the rotatable anode assembly 114 based on the operating characteristic, as indicated in block 1008. In one embodiment, adjusting operation of the rotatable anode assembly 114 includes increasing or decreasing the power provided to drive rotation of the rotatable anode assembly 114 from the anode driver 770, as discussed in connection with FIG. 8. In one embodiment, adjusting operation of the rotatable anode assembly 114 includes allowing or preventing exposure of the rotatable anode assembly to an electron beam generated by the x-ray tube 100, as discussed in connection with FIG. 9.

In one embodiment, the method 1000 can further include recording the rate of rotation and the power provided over time. This information, tracked over time, can be used to generate a life expectancy of the x-ray tube 100 or to provide a user with information relevant to maintenance and warranty service.

In one embodiment, the power provided to drive rotation of the rotatable anode assembly 114 is three-phase power. Determining the operating characteristic can include comparing a rotation frequency of the rotatable anode assembly 114 to a frequency of the three-phase power. Thus, the power provided can be determined using a power sensor tracking the frequency of the three-phase power provided by a generator, the current coming from the generator, or the voltage coming from the generator.

Accordingly, aspects of the present disclosure relate to systems, apparatuses, and methods for anode rotation sensing in x-ray tubes.

In at least one embodiment, an x-ray assembly 700 includes an x-ray tube 100 including an electric motor 766. The electric motor 766 includes a rotatable anode assembly 114. The x-ray assembly 700 includes an anode rotation sensor 768 operable to generate a signal corresponding to a rate of rotation of the rotatable anode assembly 114. The x-ray assembly 700 includes an anode driver 770 operable to drive the electric motor 766. The x-ray assembly 700 includes a power monitoring sensor 772 operable to determine a power property (i.e., at least one power property) provided to the electric motor 766 from the anode driver. The x-ray assembly 700 includes a processor 778 and a non-transitory CRM 750 having encoded electronic instructions which, when executed by the processor 778, cause the processor 778 to: i) determine, via the power monitoring sensor 772, the power property provided to the electric motor 766 from the anode driver 770, ii) determine, via the anode rotation sensor 768, the rate of rotation of the rotatable anode assembly 114, and iii) determine an operating characteristic of the rotatable anode assembly 114 based on the power property and the rate of rotation.

In one embodiment, the anode rotation sensor 768 includes a magnetic sensor 104 configured to detect a magnetic field generated by a magnetic element, such as the magnet 102, rotatable with the rotatable anode assembly 114.

In one embodiment, the operating characteristic includes a discrepancy between an expected rate of rotation of the rotatable anode assembly 114 and the rate of rotation of the rotatable anode assembly 114.

In one embodiment, the rotatable anode assembly 114 includes a bearing 164 usable to guide rotation of the rotatable anode assembly 114. The operating characteristic includes an estimated life span characteristic of the bearing 164.

In one embodiment, the x-ray assembly 700 further includes a temperature sensor 790 configured to measure a temperature within the x-ray tube 100. The estimated life span characteristic of the bearing 164 is determined at least partially based on the temperature within the x-ray tube 100.

In one embodiment, the x-ray assembly 700 further includes an acceleration sensor 782 configured to measure an acceleration of the x-ray tube 100. The estimated life span characteristic of the bearing 164 is determined at least partially based on the acceleration of the x-ray tube 100.

In one embodiment, the electronic instructions are further configured to cause the processor 778 to adjust a property of power provided to the electric motor 766 based on the operating characteristic of the rotatable anode assembly.

In one embodiment, the electronic instructions are further configured to cause the processor 778 to allow or prevent exposure of an electron beam of the x-ray tube 100 to the rotatable anode assembly 114 based on the operating characteristic of the rotatable anode assembly 114.

In one embodiment, the x-ray assembly 700 further includes a PCC 776 configured to receive a feedback signal from the processor 778 (or other component of TAU 774) indicating the operating characteristic of the rotatable anode assembly 114 and to provide a control signal to the anode driver 770 based on the feedback signal.

In at least one embodiment, a method of controlling an x-ray assembly 700 includes determining, via an anode rotation sensor 768, a rate of rotation of a rotatable anode assembly 114 within an x-ray tube 100. The method further includes determining, via at least one power sensor 772, power provided to drive rotation of the rotatable anode assembly 114 from a generator (e.g., anode driver 770). The method further includes determining an operating characteristic of the rotatable anode assembly 114 based on the rate of rotation and the power provided. The method further includes adjusting operation of the rotatable anode assembly 114 based on the operating characteristic.

In one embodiment, the operating characteristic includes a discrepancy between an expected rate of rotation of the rotatable anode assembly 114 and the rate of rotation of the rotatable anode assembly 114.

In one embodiment, adjusting operation of the rotatable anode assembly 114 includes increasing or decreasing the power provided to drive the rotation of the rotatable anode assembly 114 from the generator 770.

In one embodiment, adjusting operation of the rotatable anode assembly 114 includes allowing or preventing exposure of the rotatable anode assembly 114 to an electron beam generated by the x-ray tube 100.

In one embodiment, the method further includes recording the rate of rotation and the power provided over time.

In one embodiment, the power provided to drive rotation of the rotatable anode assembly 114 is three-phase power. Determining the operating characteristic includes comparing a rotation frequency of the rotatable anode assembly 114 to a frequency of the three- phase power.

In at least one embodiment, an x-ray assembly 700 includes a means for sensing a rate of rotation of a rotatable anode assembly 114, the rotatable anode assembly 114 being positioned within an x-ray tube 100. The x-ray assembly 700 includes a means for driving rotation of the rotatable anode assembly 114 relative to an enclosure 106 of the x-ray tube 100. The x-ray assembly 700 includes a means for controlling the means for driving rotation based on a signal generated by the means for sensing the rate of rotation.

The means for sensing the rate of rotation of the rotatable anode assembly 114 includes a magnet 102, a sensor 104, and a shield 130. Additionally or alternatively, the means for sensing the rate of rotation of the rotatable anode assembly 114 includes an anode rotation sensor 768.

The means for driving rotation of the rotatable anode assembly 114 includes an anode driver 770 and an electric motor 766.

The means for controlling the means for driving rotation includes a processor 778.

In one embodiment, the means for sensing the rate of rotation includes a means for detecting a magnetic field output by a magnetic element rotatable with the rotatable anode assembly 114. The means for detecting the magnetic field includes a sensor 104 and a shield 130. Additionally or alternatively, the means for sensing includes the anode rotation sensor 768.

In one embodiment, the signal generated by the means for sensing the rate of rotation includes a series of pulses corresponding to a frequency of rotation of the rotatable anode assembly within the x-ray tube.

In one embodiment, the means for driving rotation includes a stator 110.

In one embodiment, the x-ray assembly 700 further includes a means for recording the rate of rotation of the rotatable anode assembly 114 and a signal output by the means for driving rotation of the rotatable anode assembly 114 over time. The means for recording can include the CRM 750.

In some embodiments, an x-ray assembly may comprise an insert, an electric motor, a cathode, an anode positioned in the insert, a sensor operable to detect movement of the anode within the insert, an anode driver configured to provide a power level to the electric motor, a processor, and a non-transitory computer readable medium containing electronic instructions that, when executed by the processor, cause the processor to adjust the power level of the electric motor in response to a signal generated by the sensor.

In one embodiment, the sensor comprises a magnetic sensor operable to detect a magnetic element of the anode.

In one embodiment, the instructions further cause the processor to allow or prevent exposure of an electron beam to the anode in response to the signal generated by the sensor.

In one embodiment, the signal indicates a rate of rotation of the anode.

In one embodiment, the x-ray assembly further comprises a bearing supporting the anode, wherein the instructions further cause the processor to estimate a life span of the bearing based at least on the signal generated by the sensor.

While these systems and methods have been described with reference to exemplary embodiments, it will be understood by those skilled in the art that various changes may be made and equivalents can be substituted to adapt these teachings to other problems, materials, and technologies, without departing from the scope of the claims. Features, aspects, components or acts of one embodiment may be combined with features, aspects, components, or acts of other embodiments described herein. The disclosure is thus not limited to the particular examples that are disclosed, but encompasses all embodiments falling within the appended claims.

What is claimed is:

1. An x-ray assembly, comprising:
a rotatable anode assembly including:
an anode drivable by a stator to rotate about an axis of rotation; and
at least one magnet positioned on and rotatable with the anode about the axis of rotation.

2. The x-ray assembly of claim 1, further comprising:
an enclosure including a wall, wherein the anode is positioned within the wall;
the stator positioned external to the wall; and
a sensor configured to sense a magnetic field of the at least one magnet through the wall.

3. The x-ray assembly of claim 2, wherein the sensor is directly coupled to the wall.

4. The x-ray assembly of claim 2, further comprising a shield surrounding the sensor, wherein a portion of the shield is open toward the anode.

5. The x-ray assembly of claim 4, wherein the shield comprises a relative permeability of greater than or equal to 15,000.

6. The x-ray assembly of claim 4, wherein the shield comprises a material comprising at least one of: mu-metal, nanoperm, permalloy, metaglas, or 99.95% pure hydrogen-annealed iron.

7. The x-ray assembly of claim 2, wherein the wall is positioned at an opposite end of the rotatable anode assembly relative to a cathode of the x-ray tube.

8. The x-ray assembly of claim 2, wherein a longitudinal axis of the sensor is alignable with the at least one magnet through the wall.

9. The x-ray assembly of claim 2, wherein the sensor comprises an inductive magnetic sensor configured to sense a change in current in response to movement of the magnetic field of the at least one magnet.

10. The x-ray assembly of claim 1, wherein the at least one magnet is positioned at a perimeter of the anode.

11. The x-ray assembly of claim 1, wherein the at least one magnet includes at least two magnets circumferentially spaced around the anode.

12. A method of detecting rotation of an anode in an x-ray tube, the method comprising:
providing a sensor at a wall of an enclosure of an x-ray tube;
rotating an anode within the enclosure;
providing at least one magnet on the anode, wherein the at least one magnet is rotatable with the anode about an axis of rotation of the anode; and
detecting a change in a signal produced by the sensor in response to movement of a magnetic field of the at least one magnet as the anode rotates within the wall of the enclosure.

13. The method of claim 12, wherein providing the sensor at the wall comprises positioning the sensor with an end of the sensor alignable with the at least one magnet.

14. The method of claim 12, further comprising positioning a shield around the sensor, the shield being configured to redirect a second magnetic field from the sensor.

15. The method of claim 12, wherein detecting the change in the signal comprises detecting a plurality of temporally spaced apart pulses in the signal.

16. The method of claim 12, wherein the sensor is an inductive sensor configured to sense a change in current.

17. An x-ray tube assembly, comprising:
an insert;
a stator positioned around the insert;
a magnetic sensor including an end facing toward an interior of the insert and the stator; and
a magnetic shield surrounding the magnetic sensor and being open at the end facing toward the interior of the insert.

18. The x-ray tube assembly of claim 17, further comprising an anode assembly including a rotor positioned within and rotatable relative to the stator and at least one magnet rotatable with the rotor, and wherein the magnetic sensor is configured to sense a magnetic field of the at least one magnet.

19. The x-ray tube assembly of claim 18, wherein the insert comprises a wall, the at least one magnet being positioned within the wall, and the magnetic sensor being positioned on or outside the wall.

20. The x-ray tube assembly of claim 18, wherein the at least one magnet comprises at least two magnets positioned spaced apart on the rotor, wherein the at least two magnets are movable past the magnetic sensor as the rotor rotates relative to the stator.

21. The x-ray tube assembly of claim 17, wherein the magnetic sensor comprises an elongated shape having an elongated length surrounded by the magnetic shield.

22. The x-ray tube assembly of claim 17, wherein the magnetic shield comprises a material having a relative permeability about 8,000 or more.
